(19) United States
(12) Patent Application Publication
(10) Pub. No.: US 2006/0225363 A1
(43) Pub. Date: Oct. 12, 2006

(54) Window balance system

(75) Inventors: Tobias Peter Dallas, Rochester, NY (US); Jeffrey Charles Robertson, Rochester, NY (US)

Correspondence Address: BROWN & MICHAELS, PC;400 M & T BANK BUILDING, 118 NORTH TIOGA ST, ITHACA, NY, 14850, US

(73) Assignee: Caldwell Manufacturing Company, Rochester, NY (US)

(21) Appl. No.: 11/386,140

(22) Filed: Mar. 22, 2006

Related U.S. Application Data
(60) Provisional application No. 60/664,213, filed on Mar. 22, 2005.

(51) Int. Cl. E05D 15/22

(52) U.S. Cl. 49/446; 49/176

(57) ABSTRACT

A window balance system includes a tilt lock carrier connected to a balance for a tilt sash so that the carrier and other components of the balance can be inserted laterally through a slot in a front wall of a balance channel, rather than requiring assembly length wise from an open end of the channel. The preferred way of accomplishing this is by configuring the carrier in a channel shape with spaced apart side walls bearing locking elements and a pivot allowing the carrier to be folded up to straddle a connector or balance in a compact configuration that is laterally insertable.

### REFERENCE TO RELATED APPLICATIONS

This application claims an invention that was disclosed in Provisional Application No. 60/664,213, filed 22 Mar. 2005, entitled Window Balance System. The benefit under 35 USC §119(e) of the United States provisional application is hereby claimed, and the aforementioned application is hereby incorporated herein by reference.

### FIELD OF THE INVENTION

This invention relates to balances and tilt carrier locks for tilt sash.

### BACKGROUND

Tilt lock carriers for tilt sash balances are generally known and are available in many configurations. They nevertheless suffer from several problems including cost, durability, reliable operation, and convenience of assembly and repair.

### SUMMARY

This invention aims at reducing the cost and improving the performance of tilt lock carriers for tilt sash balances. It applies to a tilt lock carrier that when properly oriented can be inserted laterally into a balance channel through the slot in the front wall of the balance channel. This avoids the inconvenience and limitations of having to insert a tilt carrier end wise into an open end of a balance channel and allows later insertion of a replacement balance into an assembled window. Lateral insertion of the carrier through the balance slot can preferably occur when the-carrier is connected to the balance and folded up into a compact position allowing the balance and the carrier to be inserted together through the channel slot and into the balance channel. The preferred attachment of the tilt lock carrier to the balance not only accommodates folded up insertion of the carrier and balance through the balance slot and into the balance channel, but also preferably accommodates right- and left-hand orientation of the carrier relative to the balance. This allows a single combination of balance, connector, and tilt lock carrier to be deployed on either side of a tilt sash. The preferred combination also quickly and conveniently accommodates adjustments to either right or left orientation while enabling lateral assembly of the balance components into a window jamb.

### DRAWINGS

FIG. 1 illustrates one embodiment of a window having a tiltable sash.

FIG. 2 schematically illustrates one embodiment of a balance system for a tiltable sash.

FIGS. 3A and 3B illustrate one embodiment of a balance system for a tiltable sash.

FIGS. 4A and 4B illustrate the embodiment from FIGS. 3A, 3B of a balance system for a tiltable sash installed and unlocked in a jamb track.

FIGS. 5A and 5B illustrate the embodiment from FIGS. 3A, 3B of a balance system for a tiltable sash installed and locked in a jamb track.

FIG. 6 illustrates an embodiment of a connector to couple a sash carrier to a balance in a balance system.

FIGS. 7A-7C illustrate an embodiment of an assembly process to couple the connector and the balance of FIG. 6.

FIGS. 8A and 8B illustrate an embodiment of a connector to couple a sash carrier to a balance in a balance system.

FIGS. 9A-9C illustrate an embodiment of an assembly process to couple the connector and the balance of FIG. 8A.

FIGS. 10-12 illustrate embodiments of a balance system featuring a foldable carrier.

FIG. 13 illustrates alignment of an embodiment of a balance system with a jamb track for installation purposes.

FIG. 14 illustrates one embodiment of a balance system installation in a jamb track.

FIGS. 15A-15E illustrate another embodiment of a balance system installation in a jamb track.

FIGS. 16A and B, FIGS. 17A and B, and FIGS. 18A and B schematically show three respective views of preferred embodiments of balance, connector, and tilt lock carrier orientable between right- and left-hand deployment positions.

FIG. 18C is a plan view of a connector preferred for the embodiment of FIGS. 18A and B.

FIGS. 19A and B are isometric views of a preferred embodiment of tilt lock carrier formed of resin with metal locking teeth.

FIG. 19C is an isometric view of metal locking teeth incorporated into the tilt lock carrier of FIGS. 19A and B.

### DETAILED DESCRIPTION

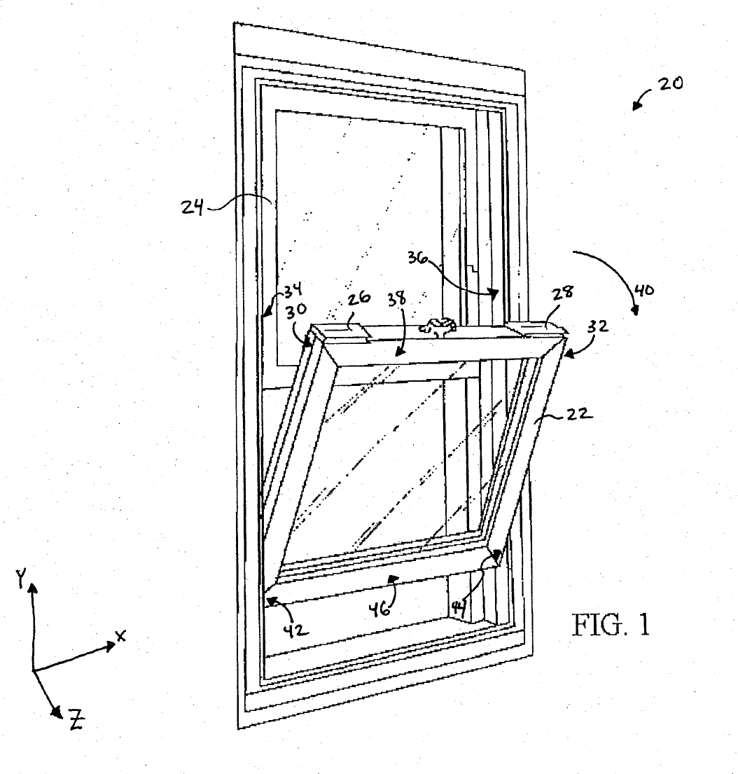

FIG. 1 illustrates one general embodiment of a window 20 having a tiltable and slidable sash 22. Such a window 20 may come in a single-hung configuration where there is only one tiltable and slidable sash 22. Alternately, the window 20 may come in a double-hung configuration where the upper sash 24 is tiltable and slidable in a manner similar to sash 22. For simplicity, only a single tiltable and slidable sash 22 will be described, but it is apparent that the principles described herein, and their equivalents, are equally applicable to double hung windows. The sash 22 has a set of tilt latches 26, 28 which may be manipulated to release the upper corners 30, 32, respectively from a left jamb track 34 and a right jamb track 36, thereby allowing an upper side 38 of the sash 22 to be pulled in an outward arc 40 into the illustrated tilted-out state of FIG. 1.

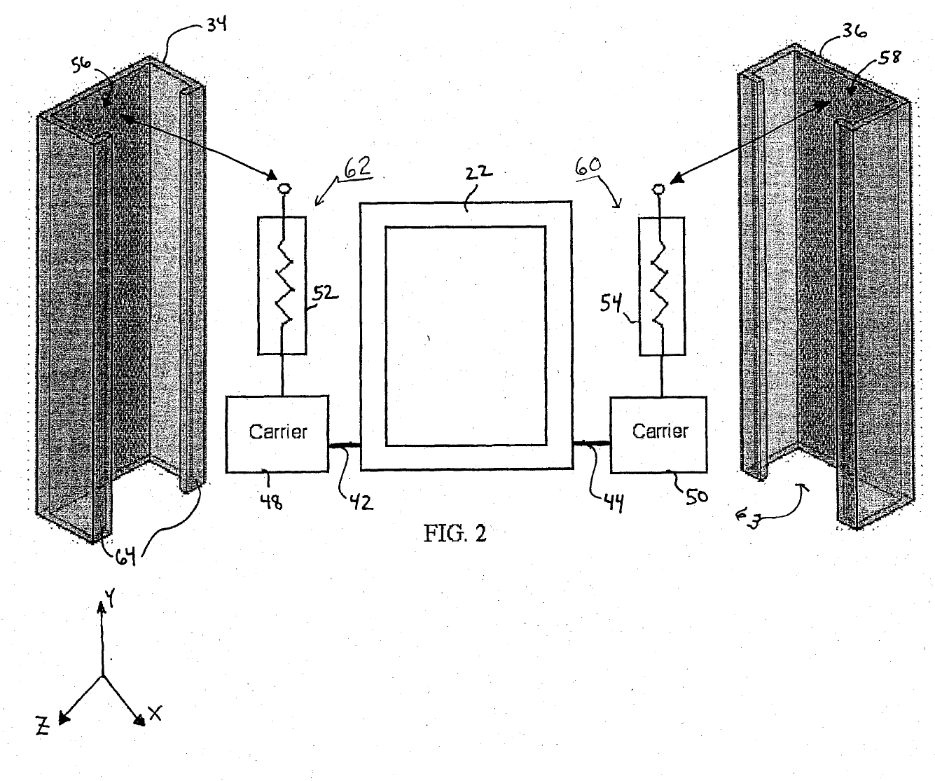

When the sash 22 is not tilted out, the sash 22 is in a plane substantially parallel to the plane of sash 24. Left and right pivot bars or sash pins 42 and 44 (not visible in FIG. 1, but visible in FIG. 2) extend outward from a lower side 46 of the sash 22. These pivot bars or pins 42, 44 engage carriers 48, 50 that are combined with balances 52 and 54 to move up and down with sash 22 in sash tracks or balance channels 34, 36. Balances 52 and 54 counter balance the weight of sash 22, and when sash 22 tilts, sash pins 42 and 44 cause carriers 48 and 50 to lock within balance channels 34, 36.

As shown in FIG. 2, a spring balance 54 coupled to a carrier 50 makes a balance system 60. Since the balance system 60 on the right side of the window operates in a similar fashion to the balance system 62 made up of spring balance 52 and carrier 48, only the balance system 62 will be described for simplicity. Where differences in the right 60 versus the left 62 balance systems may arise, those differences will be addressed. Ideally, a balance system 62 will be able to quickly adapt for installation with either a right or a left side of a sash 22, or not need any adaptation at all.

For ease of understanding, the balance system 62 of FIG. 2 is schematically illustrated outside of the jamb channel 34. In real use, the balance system 62 is installed inside the balance track 34, where the carrier 48 is constrained within the flanges 64 of the jamb track 34. The spring balance 52 may be made from many types of energy storage devices known to those skilled in the art, including, for example, a block and tackle pulley system, a compression spring, a bungee cord, a gas shock, a coil spring, a pulley and counterweight, or any combination thereof. The balance 52 may also include a motor driven balance.

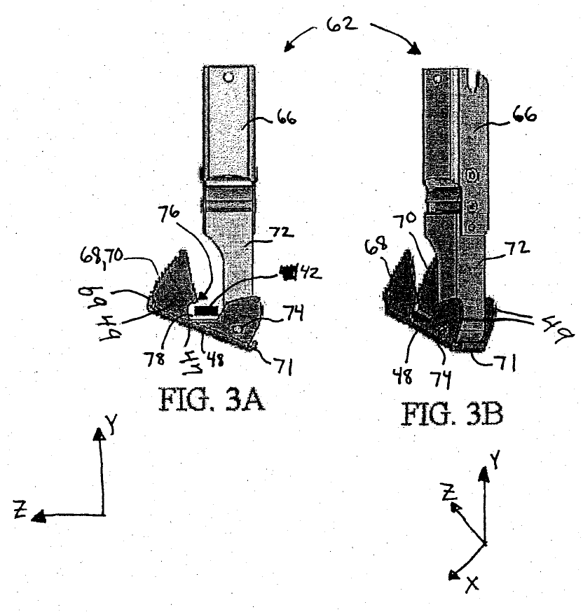

FIGS. 3A and 3B illustrate one preferred embodiment of a balance system 62 for a tilt sash. This embodiment has a partially illustrated block and tackle 66 for its spring balance 52, although other spring balances can be used. Connector 72 attaches to balance 66 and supports carrier 48, which can receive sash pin 42, as shown in FIG. 3A. Carrier 48 is preferably formed of sheet metal in a generally channel-shaped configuration with opposite side walls 49 extending upward from channel bottom 47. A pivot 74 preferably in the form of a rivet connects carrier 48 to connector 72 so that carrier 48 can pivot up and down relative to its orientation in a window. A toe or forward region 69 of carrier 48 is formed at a locking end of carrier bottom 47, and a heel or rear region 71 is formed opposite toe region 69 and includes pivot 74. Locking teeth 68, 70 are formed above toe region 69 on opposite side walls 49 of carrier 48.

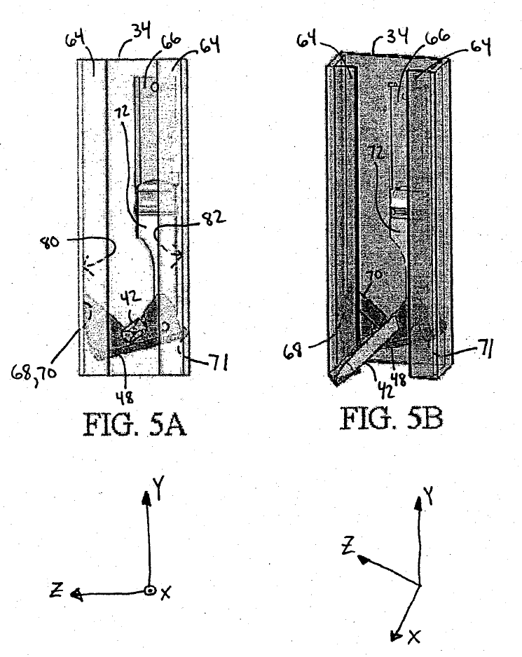

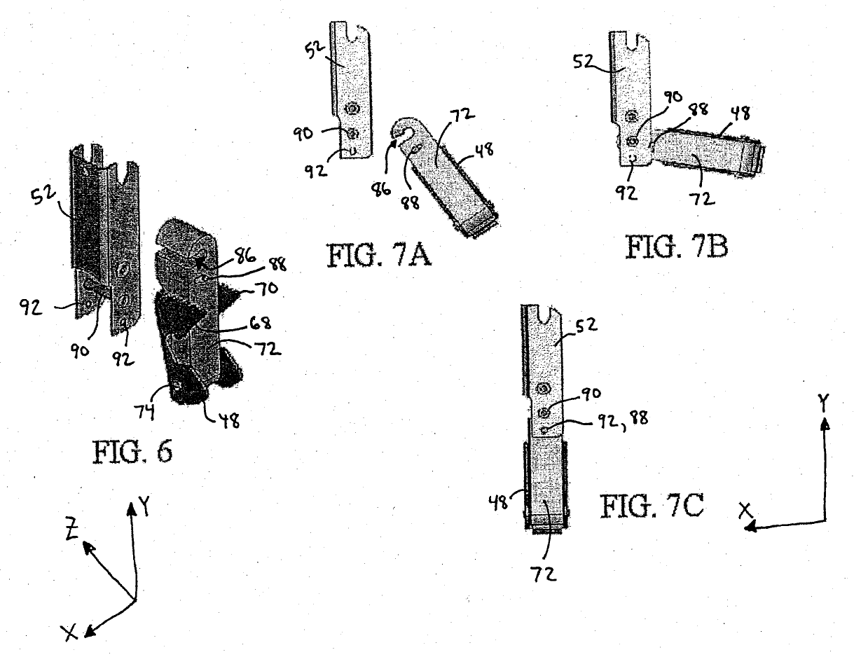

Carrier 48 is shown in a deployed position in FIGS. 3A and B, but carrier 48 can turn on pivot 74 to a downward or locking position shown in FIGS. 5A and B, and can also pivot upward to a folded position shown in FIG. 6. The folded up position of carrier 48 facilitates convenient assembly of the balance system into a balance channel, as explained below.

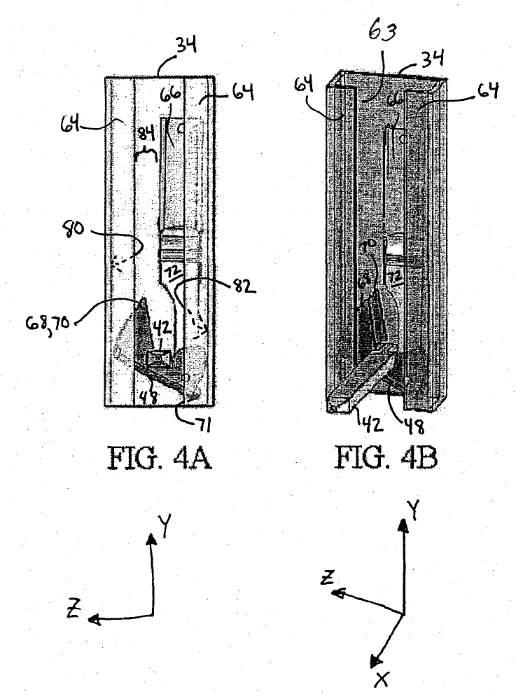

FIGS. 4A and 4B illustrate the embodiment of a balance system 62 from FIGS. 3A and 3B installed and unlocked in jamb track 34. Since pivot bar 42 from sash 22 interacts with hook 76 in slot 78 of carrier 48 (as shown in FIGS. 3A, B) the orientation of sash 22 determines the orientation of carrier 48. The hook 76 and the receiving slot 78 of carrier 48 may be configured such that the orientation of the pivot bar 42, when the sash 22 is in an upright position, causes the carrier 48 to be in an unlocked position, such as that illustrated in FIGS. 4A and 4B. In an unlocked position, the carrier teeth 68, 70 are not in locking contact with the inside or side wall surface 80 of balance channel 34. Heel 71 or toe 69 of carrier 48 may be guiding on channel surfaces 80 and 82 in this unlocked position in which sash 22, and carrier 48 can move up and down while carrier 48 and balance 66 support the weight of sash 22.

This embodiment allows the balance 66 to be installed to one side of balance channel 34, leaving a slot or gap 84 open between the jamb track flange 64 on one side and the balance 66 on the other side. This gap 84, which will be present on both the left and right window jambs, simplifies reinstallation of a sash 22 that has been removed from the window. It is only necessary to insert sash pins 42 and 44 into respective channels 84 and to lower the bottom of the sash 22 down until the sash pins 42 and 44 engage the receiving slots 78 in carriers 48 on each side of the window.

FIGS. 5A and 5B illustrate an example of a locked position for the balance system embodiment of FIGS. 3A-4B. The pivot bar 42 rotates counterclockwise about an axis parallel to the x-axis when the sash 22 tilts out of the window frame. This causes the carrier 48 to rotate downward bringing teeth 68, 70 into contact with inside wall 80 of balance track 34. Teeth 68, 70 preferably have a saw tooth shape following an arcuate path, but can have other configurations that reliably lock against channel surface 80 when sash 22 tilts. Alternatively, the contacting surfaces 68, 70 may be roughened, or a rough material may be applied to the contacting surfaces 68, 70, such as sand paper or grit. Furthermore, the contacting surfaces 68, 70 may be made from a material which is likely to have grip, such as an elastomer or other materials adapted to provide a frictional interference. Heel 71, near carrier pivot 74, braces against an opposite inside channel wall 82 while teeth 68, 70, or other locking surfaces of carrier 48 lock against channel wall 80.

After reaching the locked position illustrated in FIGS. 5A and B, the sash 22, and consequently the pivot bar 42, are free to pivot further in a counter clockwise direction. The sash 22 will not rise in the jamb track 34 (even though the upward block and tackle 66 spring force will be greater in this state than the downward force from the weight it is supporting) because the carrier 48 is locked against upward movement.

When the sash 22 pivots back into an upright position, the illustrated pivot bar 42 of FIGS. 5A and 5B rotates in a clockwise direction as viewed in the figures. In doing so, the pivot bar 42 engages hook 76 of carrier slot 78 causing the carrier 48 to rotate. As this occurs, carrier heel 71 and teeth 68, 70 disengage from the inside surfaces 80, 82 of the jamb track and return to the unlocked position illustrated in FIGS. 3 and 4.

FIG. 6 illustrates an embodiment of a connector 72 to couple a foldable sash carrier 48 to a balance 52 in a window balance system. The foldable nature of the sash carrier 48 can be seen in this view, as the carrier 48 has been pivoted up about folding axis 74 such that multiple tooth surfaces 68, 70 straddle connector 72. This simplifies installation of the carrier by allowing it to pass through a slot in the front wall of a balance channel even though carrier 48 extends for the full inside width of a balance channel when unfolded and deployed for operation.

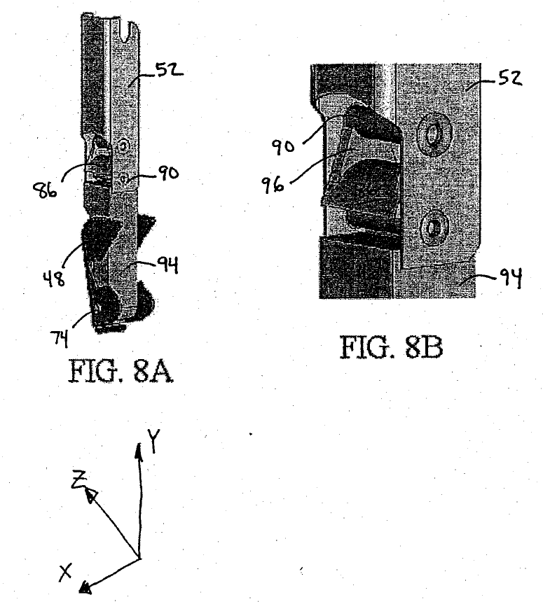

Connector 72, as shown in FIG. 7, can connect to balance 52 in either a right- or a left-hand orientation to dispose carrier 48 on the desired side of balance 52 for either the right or left sides of the window jamb. To facilitate this, connector 72 has a hook 86 and resilient tabs or stops 88 that interact respectively with a cross pin or rivet 92 extending across the channel end of balance 52 and holes 92 in side walls of balance 52.

FIGS. 7A-7C illustrates preferred steps of an assembly of the connector 72 and the balance 52 of FIG. 6. First, in FIG. 7A, the connector 72 is aligned on one side of the balance 52 so that the connector hook 86 is positioned to engage the balance pin 90. Then, in FIG. 7B, the connector hook 86 is placed over the balance pin 90. At this initial point, the resilient tabs 88 may start to engage the balance 52. With the connector hook 86 coupled to the balance pin 90, the connector 72 is rotated downward around the balance pin 90, until the resilient tabs 88 engage the balance holes 92. Alternately, the resilient tabs 88 may be inserted before the connector hook 90. Further rotation of the connector 72 is inhibited by the use of the resilient tabs 88, or some similar engagement with a stop on the balance 52. The connector 72 and carrier 48 may be attached on either side of the balance pin 90 to allow simple configuration of the balance system for both left and right sides of the window.

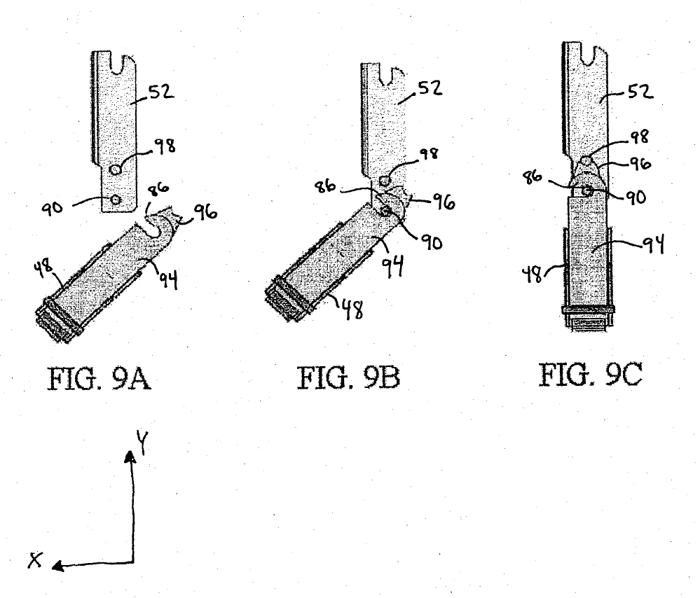

FIGS. 8A and 8B illustrate another embodiment of a connector 94 coupling a sash carrier 48 to a balance 52 in a balance system. Similar to the connector 72 of FIG. 6, the connector 94 of this embodiment has a connector hook 86 which is designed to couple with balance pin 90. Instead of resilient tabs, however, this embodiment has at least one stand-up, or detent 96 to engage with a stabilizing pin 98 in the balance 52 channel. The stabilizing pin 98 may also be the pin to which one end of a balance spring is attached.

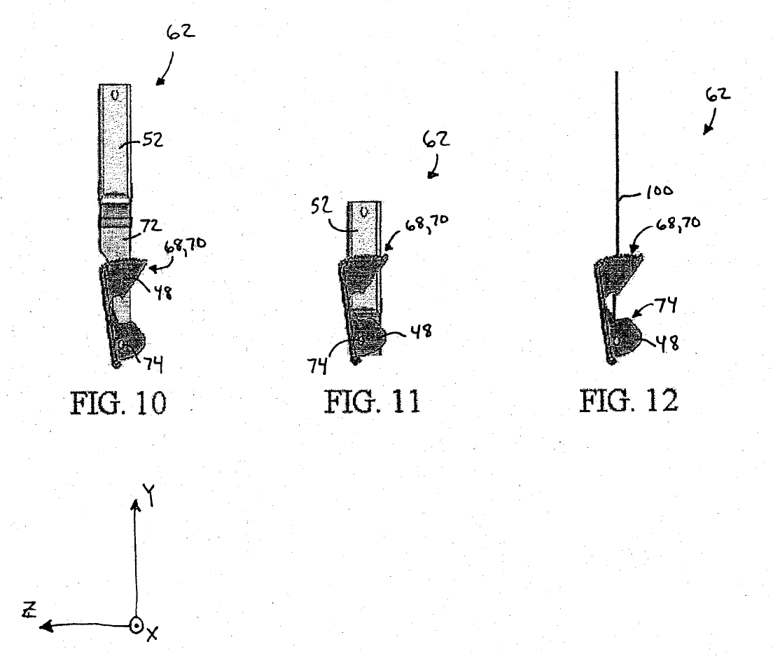

FIGS. 9A-9C illustrate an embodiment of an assembly process to couple the connector 94 and the balance 52 of FIGS. 8A and 8B. First, in FIG. 9A, the connector 94 is aligned on one side of the balance 52 so that the connector hook 86 is positioned to engage the balance pin 90. Then, in FIG. 9B, the connector hook 86 is placed over the balance pin 90. With the connector hook 86 coupled to the balance pin 90, the connector 94 is rotated to the side, around the balance pin 90, until the one or more detents 96 on the connector 94 engage with the stabilizing pin 98 to prevent the rotation of the connector 94. The connector 94 and carrier 48 may be attached on either side of the balance pin 90 to allow simple configuration of the balance system for both left and right sides of a window.

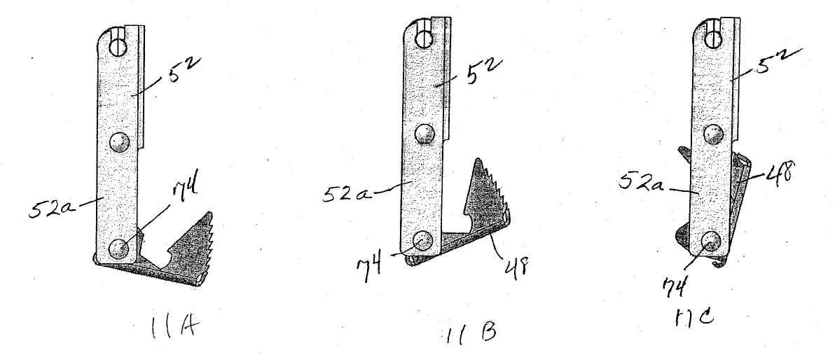

FIGS. 10-12 illustrate some of the many possibilities of connectors that can be used to attach a folding carrier to a balance. The various connectors also show different accommodations to left- and right-hand orientations of carriers for use in left- and right-hand sides of windows. In all these embodiments, besides being connected to a balance somehow, the carrier 48 is also foldable so that its heel and toe regions align with a balance slot for insertion through the balance slot. Then, an inserted carrier can be unfolded within a balance channel where it will extend from side to side within the channel for deployment.

FIG. 10 illustrates the embodiment of a balance system 62 which was discussed above. The folded up position of the sash carrier 48 can be seen in this view, as the carrier 48 has been pivoted up about the preferred rivet 74 so that locking elements 68, 70 straddle connector 72 on opposite sides of connector 72. Besides allowing the folded up carrier 48 to be inserted, along with balance 72, laterally through a slot in a front wall of a balance channel, the spaced apart orientation of locking teeth 68 and 70 ensures a secure lock against an inside balance channel wall when carrier 48 pivots downward as sash tilts. Previous balance systems, incapable of folding a carrier into a compact folded position required that the carrier and the balance be inserted end wise into a balance channel.

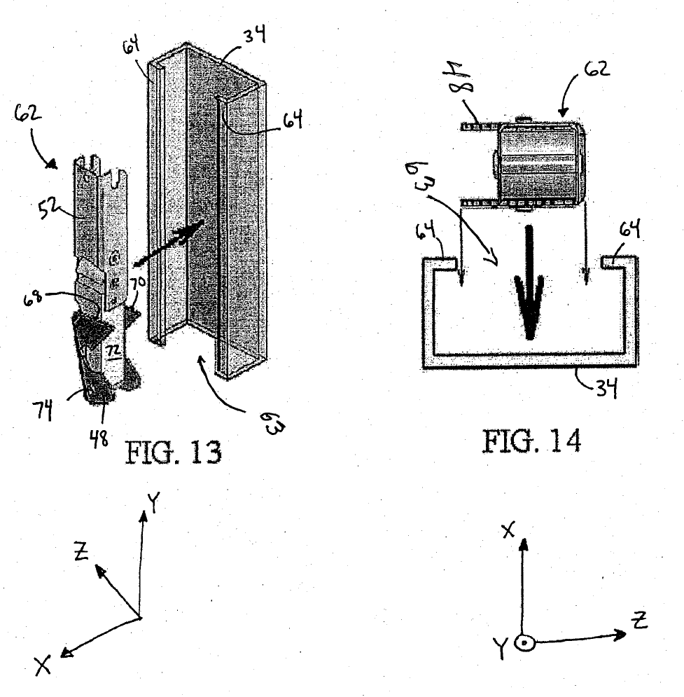

FIG. 11 illustrates another embodiment of a balance system 62. In this embodiment, the connector is a contiguous part of the balance 52. The foldable nature of the sash carrier 48 can be seen in this view, as the carrier 48 has been turned up on pivot 74 such that locking teeth 68, 70 straddle balance 52. The balance 52 of FIG. 11 is a partially illustrated block and tackle. FIGS. 11A-C show another embodiment of a foldable carrier 48 attachable directly to an extension of a balance 52 via a pivot pin 74. The folded up position of carrier 48 is illustrated in FIG. 11C, to show that carrier 48 can fold within a balance or a balance connector, as well as fold to straddle a balance or a balance connector. These views also illustrate that a connection between a foldable carrier and a balance can be as simple-as a rivet 74 establishing a pivot point for the balance. The embodiment of FIGS. 11A-C can also be installed in either side of a window, merely by rotating the balance and the carrier 180° around a vertical or Y axis.

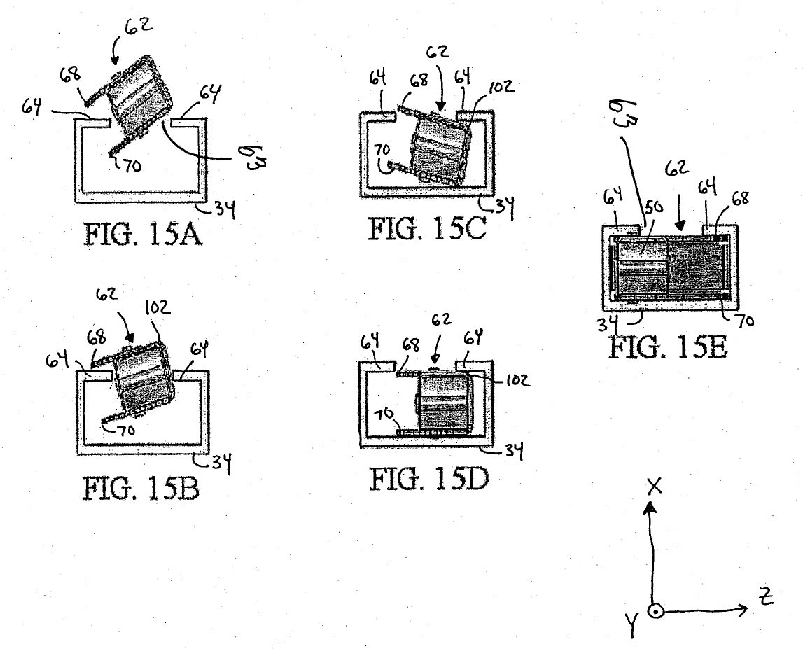

FIG. 12 illustrates a further embodiment of a balance system 62. In this embodiment, the cord 100 from a spring biasing mechanism such as a block and tackle serves as the connector to carrier 48. The cord 100 can be coupled to the carrier 48 in several ways, including a hook passing through a slot or opening in carrier 48, or by tying the cord with a knot, by gluing or epoxying the cord in place, by clipping or pinning the cord in place, or any combination of such expedients. Any such connections are preferably made in heel region 71 of carrier 48 so that the pivot region 74 for the carrier 48 becomes the coupling region for the cord 100. Cord 100 preserves the folding nature of carrier 48 which can be pivoted up to a position straddling cord 100. This also illustrates that carrier 48 can be inserted laterally into a front wall slot of a balance channel whether the carrier is attached, separated, or moved somewhat away from the body of the balance. Whether inserted separately or together, carrier 48 and the balance to which it is connected are each insertable through a front face slot of a balance channel. This also illustrates that folding of the carrier 48 turns it from a longitudinally horizontal to a longitudinally vertical position, for fitting within a balance channel slot, whether carrier 48 is in close proximity with a balance or slightly removed from a balance.

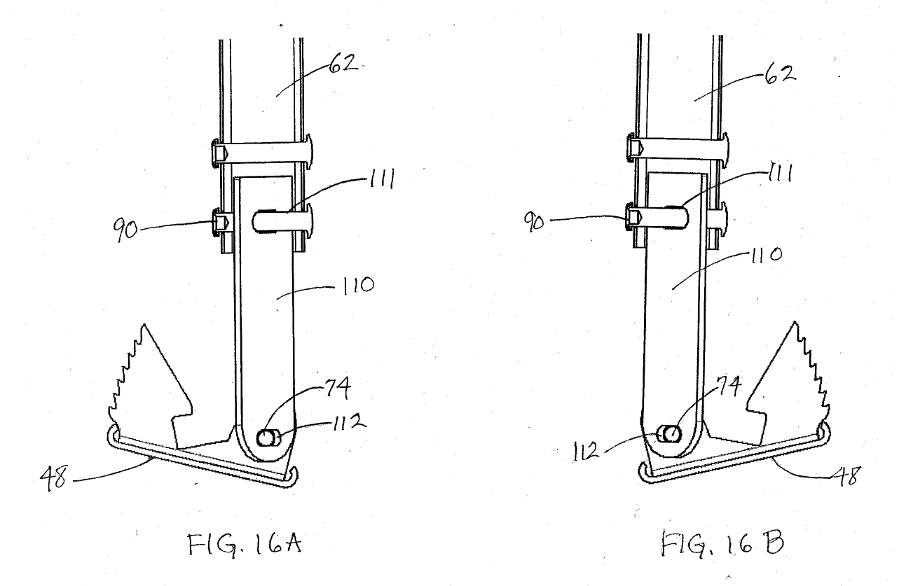

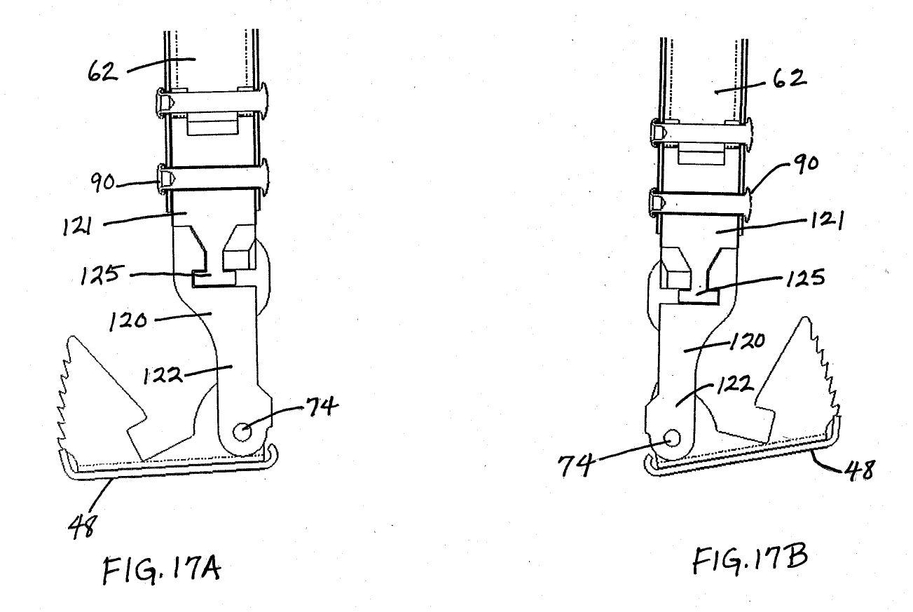

FIG. 13 illustrates alignment of an embodiment of a balance system 62 with a slot 63 of a jamb channel 34 for installation purposes. As in FIG. 10, the sash carrier 48 is pivoted and has been folded about folding axis 74 to align carrier 48 with slot 63. FIG. 14 illustrates how the folded up embodiment of balance 62 and carrier 48 of FIG. 13 can be inserted laterally through slot 63 into channel 34, providing that slot 63 is wide enough. FIG. 14 also illustrates that a folded up carrier 48, whether folded with a balance or folded while spaced from a balance, can be inserted by itself through slot 63 into a balance channel.

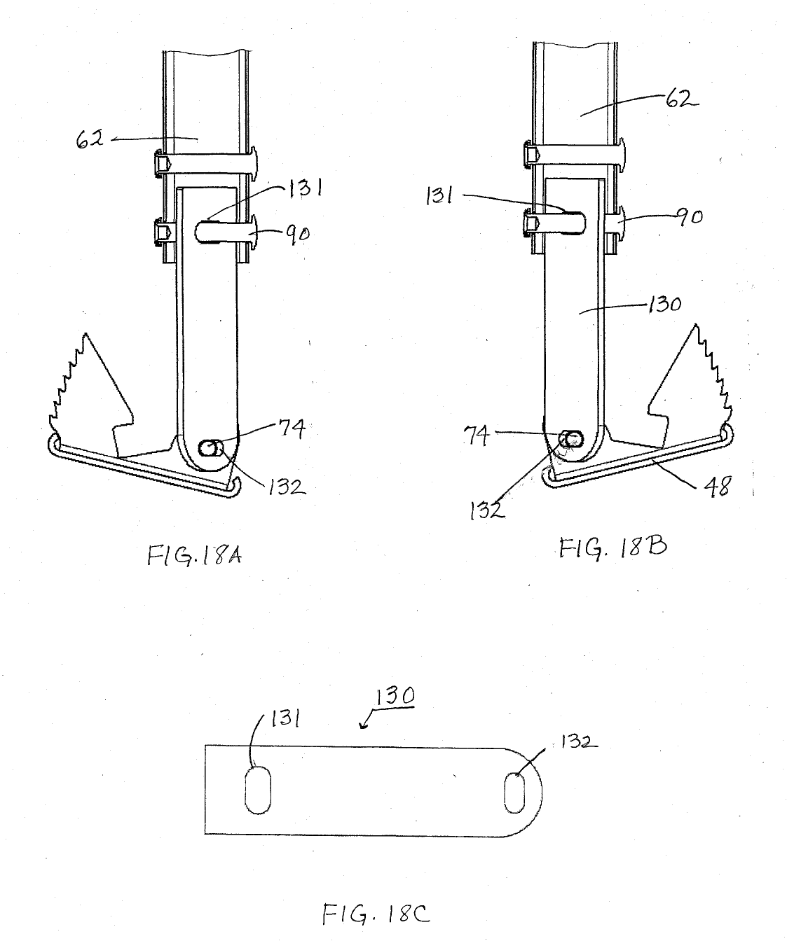

In other embodiments, such as the one illustrated in FIGS. 15A-15E, the slot 63 width or distance between the flanges 64 in the jamb track 34 may be narrower than the folded size of the balance system 62. In this case an installation method using a rotation of carrier 48 with or without the balance system 62 (around an axis substantially parallel to the Y-axis) may be used to install the balance system without the need for vertical tipping of the balance system away from the Y-axis. In an inserting action (FIG. 15A), a first contacting surface 70 of a folded carrier 48 is inserted into the side opening of a jamb track 34. In a rotating action (FIGS. 15B, 15C) a diagonally opposite corner 102 of the folded carrier 48 is rotated in a first direction into the jamb track 34 until the diagonally opposite corner 102 clears the flange 64 and ends up inside the jamb track 34. In another rotating action (FIG. 15D), a second contacting surface 68 is rotated in a direction opposite the first twisting direction so that the second contacting surface 68 and the whole folded carrier 48 ends up inside the jamb track 34. In an unfolding action (FIG. 15E), the balance 52 is pushed inside the jamb track 34 opposite the multiple contacting surfaces 68, 70, which are unfolded into a deployed position ready to receive sash pivot pins.

In either of the balance system installation methods described above, a cord from the balance 52 or the balance itself may be attached to the jamb track 34 either before, after, or during the indicated steps. Attaching the cord from the balance 52 to the jamb track first can simplify installation because the balance system is free to move about outside the jamb, making it easier to position the cord connection. Conversely, cord 100 can be attached to carrier 48, as shown in FIG. 12, and carrier 48 and the accompanying balance can be moved somewhat apart when installed separately into a balance channel.

Of particular note in these installation methods is the fact that substantially no vertical tipping of the balance system away from the Y-axis is needed to install the balance system 62 from the side. Many prior art balance systems have to be tipped vertically on their side so that they are nearly perpendicular to the jamb track to allow a T-like carrier to clear the flanges of the jamb track, then rotated to allow the balance to be tipped vertically back up and into the jamb track. The balance system embodiments and installation methods described herein do not have this limitation. In addition to being simpler to install, the embodiments herein enable the replacement of balance systems in windows where the length of the balance system is longer than the open length of slot 63 within the window frame. For such a window, balance systems that need to be tipped vertically may have difficulty being installed without disassembling the window or cutting out part of the jamb track.

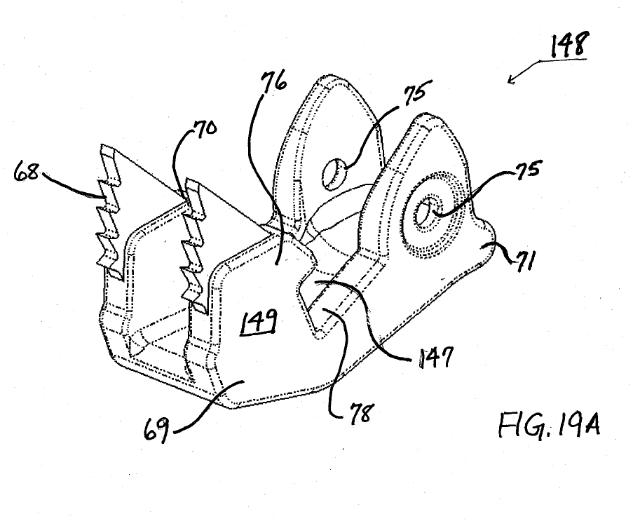

FIGS. 16-18 illustrate several other embodiments of connectors that accommodate both folding of a carrier 48 for slot insertion into a balance channel and also accommodate both right- and left-hand orientations of balance systems within windows. These embodiments are some of many alternatives to previous connectors, pivot pins, cords, etc. that can also accommodate both folding and right- and left-hand orientation of carriers 48 after slot insertion into a balance channel.

Another embodiment of a connector 110, as schematically illustrated in FIGS. 16A and B is preferably molded of resin and has an oblong slot 111 near its balance end, and another oblong slot 112 near its carrier end. Connector 110 is preferably joined to balance 62 by rivet 90 passing through oblong slot 111, and carrier 48 is preferably joined to connector 110 by rivet 74 passing through lower oblong slot 112. This arrangement allows connector 110 to rotate 90° on rivet 90 relative to balance 62, and also allows carrier 48 to rotate 90° relative to a vertical or Y axis, relative to connector 110. Thus, by rotating connector 110 through its range of freedom of movement, and similarly rotating carrier 48 relative to connector 110, the balance system can change from the left hand configuration of FIG. 16A to the right hand configuration of FIG. 16B. This makes a handedness correction for installation purposes quick and convenient.

Another preferred embodiment of a connector 120 is schematically illustrated in FIGS. 17A and B. Connector 120 is formed of an upper part 121 and a lower part 122 that are joined together by a swivel 125 that allows lower portion 122 to turn around a vertical or Y axis. A rivet 90 joins upper portion 121 to balance 62, and rivet 74 joins carrier 48 to lower portion 122. Swiveling from the left hand orientation of FIG. 17A to the right hand orientation of FIG. 17B requires merely rotating lower portion 122 around swivel 125. Portions 121 and 122 can be connected together by axial movement perpendicular to the vertical axis, and once the balance system is assembled into a balance channel, portions 121 and 122 are unable to disconnect.

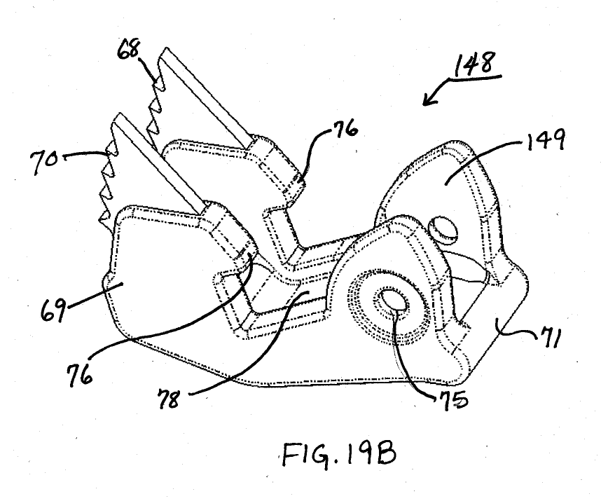

FIGS. 18A-C illustrate another preferred embodiment of a connector 130, which is formed as a simple piece of sheet metal with oblong holes 131 and 132 near each end. Rivet 90 joins connector 130 to balance 62 by extending through oblong hole 131, and rivet 74 joins tilt lock 48 to connector 130 by passing through oblong hole 132. Connector 130 is shaped to be free to rotate 90° around balance rivet 90, and similarly, the shape of connector 130 allows carrier 48 and its rivet 74 to rotate 90° relative to carrier 130. These two rotations combined, allow carrier 48 to rotate from the left hand position of FIG. 18A to the right hand position of FIG. 18B.

The connectors illustrated in FIGS. 16-18, like other connectors previously described, allow carrier 48 to pivot upward into a folded position to form a compact package insertable laterally through a front wall slot 63 into a balance channel. They also allow carrier 48 to unfold within the channel, receive and support a sash pin, and lock the balance when the sash tilts. Connectors 120 and 130 can be hybridized by having one or both ends formed of resin material with oblong slots such as used in connector 110 with a central or end region formed of sheet metal as suggested by connector 130.

Tilt lock carrier 48 as illustrated in FIGS. 3-18 is preferably formed of sheet metal that is stamped and formed to the illustrated shape. For smooth and quiet running between the inside side walls of a balance channel, is possible, and sometimes preferred, to provide carrier 48 with a resin heel 71 or toe 69 substituting for metal heel 71 and toe 69 as illustrated in FIG. 3A a resin heel or toe can be formed of molded or extruded clips attached to carrier 48 so as to glide along inside walls of a balance channel.

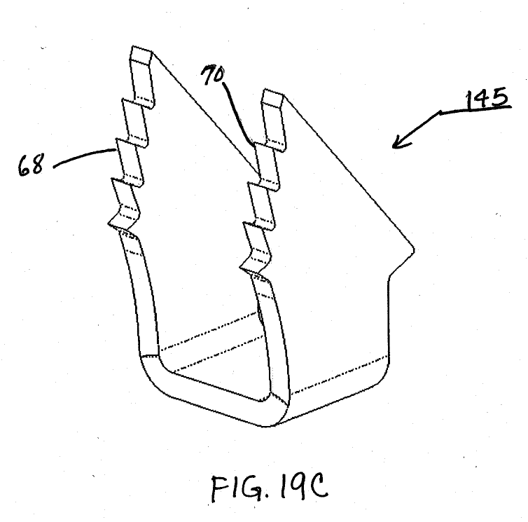

Another preferred alternative for carrier 48 is illustrated in FIGS. 19A-C. Alternative carrier 148 is preferably molded of resin material with a metal insert forming teeth 68 and 70 or some other tooth configuration including a single row of teeth. The preferred shape for carrier 148 is a similar channel configuration such as preferred for a sheet metal carrier 48, including heel-region 71, toe region 69, sash pin slot 78, and pin hook 76. Holes 75 in side walls 149 that are upstanding from bottom wall 147 can receive a rivet connecting carrier 148 to a connector.

An insert 145 that is preferred for forming carrier 148 is illustrated in FIG. 19C. Insert 145 is preferably formed of metal in a channel shape matching the shape of the resin body of carrier 148. Metal element 145 is preferably insert-molded to be incorporated into the resin body of carrier 148. The result provides a resin heel 71 and toe 69 that ride smoothly and effectively along inside walls of a balance channel. The metal teeth 68 and 70 assure a reliable lock within the balance channel, and the resin portion of the body of carrier 148 reduces the expense.

Alternatives to metal insert 145 include forming locking surfaces of carrier 148 with an elastomer or a high friction material co-molded with the rest of carrier 148. Instead of insert molding by using metal element 145, the molding can involve co-molding of two different resin materials so that the locking or breaking function at the toe region of carrier 148 is accomplished by one material while the body of carrier 148 is molded of another suitable resin.

What is claimed is:

1. An improvement in a combination of a tilt sash balance and a tilt lock carrier connected to the tilt sash balance so that the tilt lock carrier can receive a pin of a tilt sash and lock within a balance channel of a window jamb when the tilt sash tilts, the improvement comprising:
the tilt lock carrier being foldable between a deployed position and a folded up position;
the tilt lock carrier in the deployed position being dimensioned to extend between side walls of the channel;
the tilt lock carrier in the folded up position being alignable with a slot in the front wall of the balance channel; and
the balance and the tilt lock carrier in the folded up position being insertable laterally into the balance channel through the slot in the front wall of the balance channel while the balance and the tilt lock are aligned with the slot.

2. The improvement of claim 1 wherein the tilt lock carrier has a channel shape with locking elements formed of side walls of the channel shape.

3. The improvement of claim 2 wherein the locking elements are formed of metal projecting from a channel shape formed of resin.

4. The improvement of claim 2 wherein the locking element is formed of sheet metal in the channel shape with heel and toe regions extending upward from a bottom of the channel shape.

5. The improvement of claim 1 wherein a connector connects to the balance and to the tilt lock carrier, the connector is rotatable 90° at the connection to the balance, and the tilt lock carrier is rotatable 90° at the connection to the connector.

6. The improvement of claim 5 wherein rivets received in oval holes in the connector make the connections to the balance and to the tilt lock carrier.

7. The improvement of claim 1 wherein a connector is configured to connect the tilt lock carrier to the balance in alternate positions between the balance and the tilt lock carrier, and the alternate positions differ in orientation by 180°.

8. The improvement of claim 7 wherein the connector is a swivel connector that can swivel 180°.

9. The improvement of claim 1 wherein the tilt lock carrier can be unfolded to the deployed position after insertion into the balance channel in the folded up position.

10. The improvement of claim 1 including a connector connected to the balance and pivotally joined to the tilt lock carrier to allow the tilt lock carrier to fold between the deployed position and the folded up position.

11. The improvement of claim 1 wherein the tilt lock carrier has heel and toe regions that glide along inside walls of the balance channel when unlocked in the deployed position.

12. A tilt locking carrier combined with a balance and adapted to operate within a balance channel of a window jamb to balance and lock a tilted sash, the combination comprising:
the carrier being dimensioned to extend from side to side of the balance channel in a deployed position;
a heel region of the carrier being connected to the balance to allow the carrier to pivot from the deployed position to a pivoted up position;
the carrier in the pivoted up position being alignable with a slot in a front face of the balance channel; and
the carrier in the pivoted up position being dimensioned to fit laterally into the balance channel through the slot.

13. The combination of claim 12 wherein the carrier can be oriented in either of two deployed positions that differ from each other by 180°.

14. The combination of claim 12 including a connector that is attached to the balance via a rivet through an oblong hole in a balance end of the connector, the carrier is attached to a connector via a rivet through an oblong hole in a carrier end of the connector, the connector is able to rotate 90° relative to the balance, and the carrier is able to rotate 90° relative to the connector.

15. The combination of claim 12 wherein a rivet connects the carrier to the balance and provides the pivot for the carrier.

16. The combination of claim 12 wherein heel and toe regions of the carrier are formed of resin to engage side walls of the balance channel.

17. The combination of claim 16 wherein the carrier has spaced apart side walls upstanding from a bottom wall with the heel and the toe formed at opposite ends of the bottom wall.

18. The combination of claim 16 wherein a toe region of the carrier includes locking teeth that lock against a balance channel side wall when tilting of a sash pivots the carrier downward.

19. A combination of a tilt locking carrier connected to a balance, the combination being adapted to operate in a balance channel of a window jamb for a tilt sash, and the combination comprising:
the carrier having spaced apart and generally parallel walls upstanding from a bottom wall;
heel and toe regions of the carrier being formed at opposite ends of the bottom wall;
the heel and toe regions being dimensioned to slide along opposite side walls of the balance channel when the carrier is unlocked in a deployed position;
locking teeth arranged on the upstanding walls above the toe region of the carrier;
the carrier having a pivotal connection to the balance in the heel region of the carrier allowing the carrier to pivot up and down; and
the carrier is dimensioned to be laterally inserted into the balance channel through a slot in a front face of the balance channel when the heel and toe regions of the carrier are aligned with the slot.

20. The combination of claim 19 wherein the heel and toe regions of the carrier are formed of resin and the locking teeth are formed of metal.

21. The combination of claim 19 wherein the carrier is rotatable around a vertical axis relative to the balance between alternate deployed positions differing from each other by 180°.

22. The combination of claim 19 wherein rivets connect a connector to the balance and to the carrier.

23. The-combination of claim 22 wherein the connector is formed of sheet metal with rivet-receiving, oblong holes in each opposite end region of the connector.

24. The combination of claim 19 including a connector joined to the balance and pivotally connected to the carrier.

25. The combination of claim 24 wherein the connector is dimensioned to fit between the locking teeth when the carrier pivots upward.

26. A method of assembling a balance connected to a tilt lock carrier into an operative position in a balance channel of a window jamb for a tilt sash, the method comprising:
forming the carrier connection to the balance so that the carrier can pivot between the operative position and a folded position;
pivoting the carrier to the folded position;
aligning the balance with a slot in a front wall of the balance channel, and inserting the balance and the folded position carrier through the slot and into the balance channel while the balance and the carrier are aligned with the slot; and
unfolding the inserted carrier from its folded position to the operative position where the carrier extends between side walls within the balance channel.

27. The method of claim 26 including orienting the carrier relative to the balance so that when the carrier is unfolded it is disposed on a desired side of the connector.

28. The method of claim 27 including arranging lost motion joints between the carrier and balance, and rotating the carrier through a range of 180° around an axis of the balance as allowed by the lost motion joints to orient the carrier.

29. A connector attaching a tilt lock carrier to a tilt sash balance, the connector and carrier comprising:
the connector having opposite ends with oblong openings;
a balance rivet connecting one of the oblong openings to the balance;
a carrier rivet connecting another of the oblong openings to the carrier;
the connector being rotatable through a range of 90° relative to the balance rivet;
the carrier and the carrier rivet being rotatable through a range of 90° relative to the connector; and
the connector rotation and the carrier rotation allowing the carrier to deploy in either of two alternate orientations that differ by 180°.

30. The connector of claim 29 wherein the carrier rivet allows the carrier to pivot up and down relative to the connector.

31. The connector of claim 29 wherein the carrier rivet is in a heel region of the carrier.

32. The connector of claim 31 wherein the carrier has locking teeth above a toe region of the carrier.
